(19) United States
(12) Patent Application Publication
(10) Pub. No.: US 2025/0311058 A1
(43) Pub. Date: Oct. 2, 2025

(54) PLANAR HEATER MANUFACTURING METHOD, PLANAR HEATER, AND HEATING DEVICE

(71) Applicant: NHK SPRING CO., LTD., Yokohama-shi, Kanagawa (JP)

(72) Inventors: Shinji UEHARA, Yokohama-shi (JP); Ryouta YAMAGUCHI, Yokohama-shi (JP)

(21) Appl. No.: 19/081,981

(22) Filed: Mar. 17, 2025

(30) Foreign Application Priority Data
Mar. 27, 2024 (JP) 2024-051978

(51) Int. Cl. H05B 3/34; D03D 1/00; D03D 15/275; D03D 15/533

(52) U.S. Cl. CPC H05B 3/347; D03D 1/00; D03D 15/275; D03D 15/533; D10B 2401/16; D10B 2505/00; H05B 2203/016; H05B 2203/017; H05B 2203/029

(57) ABSTRACT

A planar heater manufacturing method, including: transporting a strip-shaped body, the strip-shaped body including plural electrothermal warp threads that generate heat when electricity flows therethrough and that are arranged in a row along one direction, including a single strand of weft thread that together with the electrothermal warp threads configures a cloth, and extending in an orthogonal direction that is orthogonal to the one direction, by transporting the strip-shaped body in the orthogonal direction; and connecting an electrode to the strip-shaped body so as to contact the plural electrothermal warp threads.

### CROSS-REFERENCE TO RELATED APPLICATION

This application is based on and claims priority under 35 USC 119 from Japanese Patent Application No. 2024-051978 filed on Mar. 27, 2024, the entire disclosure of which is incorporated by reference herein.

### BACKGROUND

### Technical Field

The present disclosure relates to a planar heater manufacturing method, a planar heater, and a heating device.

### Related Art

An invention disclosed in Japanese Patent Application Laid-Open (JP-A) No. 2024-009048 is provided with a planar heater serving as a heating device inside a vehicle seat.

This case envisages a configuration of a planar heater having a specific width utilizing plural electrothermal warp threads that generate heat when electricity flows through and that are arranged in a row along a given direction, and a weft thread that, together with the electrothermal warp threads, configures a strip-shaped cloth.

There is however a concern regarding each of the electrothermal warp threads breaking when trying to manufacture a planar heater with a cloth of a specific width in this manner.

### SUMMARY

The present disclosure provides a planar heater manufacturing method, a planar heater, and a heating device that are able to reduce a concern regarding electrothermal warp threads breaking of a planar heater including plural electrothermal warp threads that generate heat when electricity flows therethrough and that are arranged in a row along one direction, and including a weft thread that together with the electrothermal warp threads configures a strip-shaped cloth.

A planar heater manufacturing method according to a first aspect of the present disclosure includes: transporting a strip-shaped body, the strip-shaped body including plural electrothermal warp threads that generate heat when electricity flows therethrough and that are arranged in a row along one direction, including a single strand of weft thread that together with the electrothermal warp threads configures a cloth, and extending in an orthogonal direction that is orthogonal to the one direction, by transporting the strip-shaped body in the orthogonal direction; and connecting an electrode to the strip-shaped body so as to contact the plural electrothermal warp threads.

In the planar heater manufacturing method of the first aspect, the strip-shaped body, which includes the plural electrothermal warp threads that generate heat when electricity flows therethrough and that are arranged in a row along the one direction, includes the single strand of weft thread that together with the electrothermal warp threads configures the strip-shaped cloth, and extends in the orthogonal direction orthogonal to the one direction, is transported in the orthogonal direction. The electrode is also connected to the strip-shaped body so as to contact the plural electrothermal warp threads. Namely, the planar heater manufacturing method of the first aspect does not include a process to change a width of the strip-shaped body (planar heater) to a specific width by cutting the strip-shaped body along the orthogonal direction. This means that the planar heater manufacturing method of the first aspect is able to reduce concern regarding the electrothermal warp threads breaking in a planar heater including plural electrothermal warp threads that generate heat when electricity flows therethrough and that are arranged in a row along one direction, and including a weft thread that together with the electrothermal warp threads configures a cloth.

The planar heater manufacturing method according to a second aspect of the present disclosure is the planar heater manufacturing method of the first aspect, wherein the strip-shaped body to be transported also includes a base paper that extends in the orthogonal direction and that temporarily holds the electrothermal warp threads and the weft thread on one face of the base paper, and the planar heater manufacturing method further includes separating the base paper from the electrothermal warp threads and the weft thread.

In the planar heater manufacturing method of the second aspect, the strip-shaped body to be transported also includes the base paper that extends in the orthogonal direction and that temporarily holds the electrothermal warp threads and the weft thread on one face, and the planar heater manufacturing method further includes separating the base paper from the electrothermal warp threads and the weft thread. Manufacture of the planar heater is accordingly facilitated while the positional relationships of each of the electrothermal warp threads are maintained.

A planar heater manufacturing method according to a third aspect of the present disclosure is the planar heater manufacturing method of the first aspect or the second aspect, wherein the electrode is strip-shaped extending in the one direction, and the planar heater manufacturing method further includes cutting the strip-shaped body and the electrode along a cut line that is a straight line passing through a width direction center portion of the electrode in the one direction.

In the planar heater manufacturing method of the third aspect, the electrode is strip-shaped extending in the one direction, and the planar heater manufacturing method further includes cutting to cut the strip-shaped body and the electrode along the cut line that is a straight line passing through a width direction center portion of the electrode in the one direction. This thereby enables manufacture of two electrodes by cutting once.

A planar heater according to a fourth aspect of the present disclosure includes plural electrothermal warp threads that generate heat when electricity flows therethrough and that are arranged in a row along one direction, a single strand of weft thread that, together with the electrothermal warp threads, configures a strip-shaped body that is a cloth extending in an orthogonal direction that is orthogonal to the one direction, and a negative electrode section and a positive electrode section that have been connected to the plural electrothermal warp threads.

In the planar heater of the fourth aspect, there is a single strand of the weft thread that, together with the electrothermal warp threads, configures the strip-shaped body that is a cloth extending in the orthogonal direction orthogonal to the one direction. Namely, the planar heater of the fourth aspect is manufactured without performing a process to change the width of the strip-shaped body (planar heater) to a specific width by cutting the strip-shaped body along the orthogonal direction. There is accordingly little concern regarding breaking of the electrothermal warp threads of the planar heater of the fourth aspect.

A planar heater according to a fifth aspect of the present disclosure includes plural of planar heaters of the fourth aspect, a negative electrode conductor that has been connected to negative electrode sections of plural planar heaters, and a positive electrode conductor that has been connected to positive electrode sections of plural planar heaters.

The heating device of the fifth aspect is able to generate more heat than a single planar heater.

As described above, the planar heater manufacturing method, the planar heater, and the heating device according to the present disclosure are able to reduce concern regarding electrothermal warp threads breaking of a planar heater including plural electrothermal warp threads that generate heat when electricity flows therethrough and that are arranged in a row along one direction, and including a weft thread that together with the electrothermal warp threads configures a strip-shaped cloth.

### BRIEF DESCRIPTION OF THE DRAWINGS

Exemplary embodiments of the present disclosure will be described in detail based on the following figures, wherein:

FIG. 1 is a schematic side view of a manufacturing device capable of executing a planar heater manufacturing method according to an exemplary embodiment of the present disclosure, and a strip-shaped body;

FIG. 2 is a schematic plan view of a manufacturing device and strip-shaped bodies;

FIG. 3 is a schematic plan view of a strip-shaped body (cloth);

FIG. 4 is a schematic plan view of a strip-shaped body cut by a second cutting device;

FIG. 5 is a schematic plan view of a planar heater;

FIG. 6 is a schematic cross-section taken along arrow 6-6 of FIG. 5;

FIG. 7 is a schematic plan view of a heating device configured utilizing plural planar heaters;

FIG. 8 is a schematic plan view of a planar heater of a first modified example;

FIG. 9 is a schematic plan view of a planar heater of a second modified example; and

FIG. 10 is a schematic cross-section taken along arrow 10-10 of FIG. 9.

### DETAILED DESCRIPTION

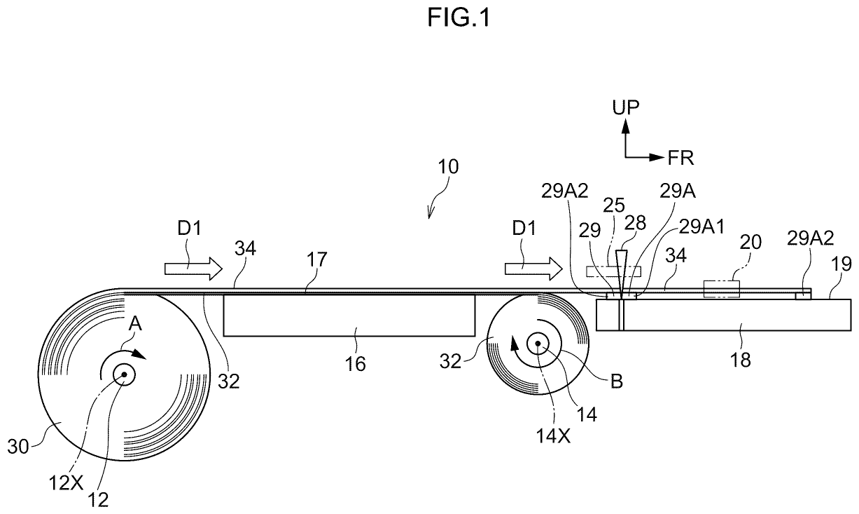

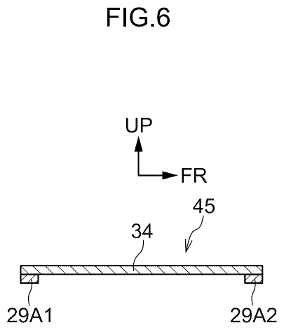

Description follows regarding a planar heater manufacturing method, a planar heater, and a heating device according to an exemplary embodiment of the present disclosure, with reference to FIG. 1 to FIG. 7. Note that, as appropriate in the drawings, arrow FR indicates forwards in a front-rear direction, an arrow UP indicates upward in a height direction, and an arrow LH indicates a left side in a left-right direction.

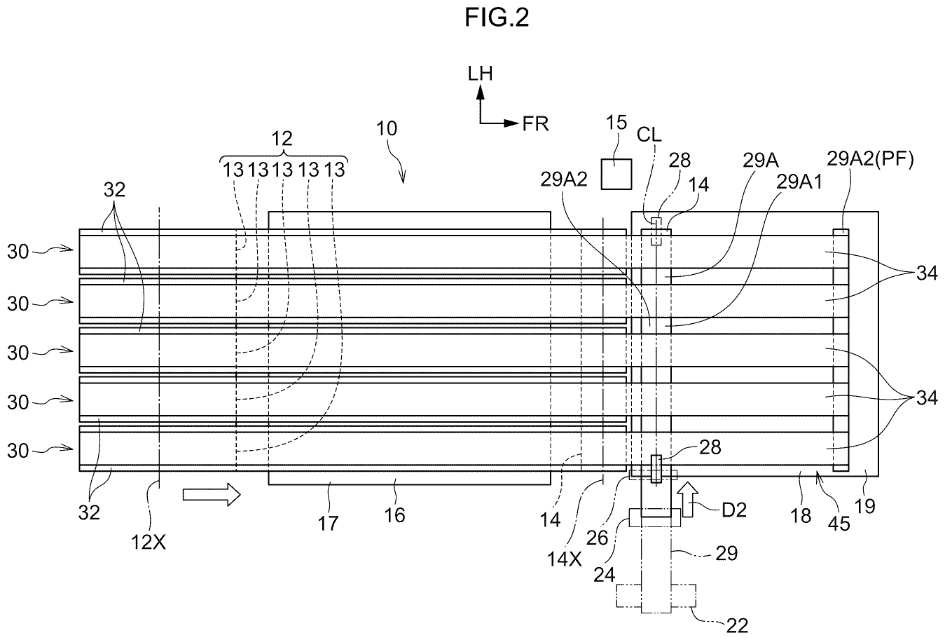

A manufacturing device 10 illustrated in FIG. 1 and FIG. 2 is a device capable of executing a planar heater manufacturing method according to an exemplary embodiment. The manufacturing device 10 includes a follower roller unit 12, a drive roller 14, a drive device 15, a first support table 16, a second support table 18, a transport device 20, a follower roller 22, an adhesive coating device 24, a pressing device 25, a first cutting device 26, and a second cutting device 28. The drive device 15, the transport device 20, the adhesive coating device 24, the pressing device 25, the first cutting device 26, the second cutting device 28, a later-described width direction feed device, and a later-described transport robot are controlled by a control device (omitted in the drawings) of the manufacturing device 10.

As illustrated in FIG. 2, the follower roller unit 12 includes five rollers 13 that each have the same diameter and same axial direction, and that are arranged in a row along the left-right direction. The rollers 13 are each able to rotate in the arrow A direction illustrated in FIG. 1 about a common rotation axis 12X extending along the left-right direction while synchronized with each other.

A rotation axis 14X of the drive roller 14 provided at a position separated from, and in front of, the follower roller unit 12 is parallel to the rotation axis 12X. The drive roller 14 utilizes drive force generated by the drive device 15 to rotate about the rotation axis 14X in an arrow B direction illustrated in FIG. 1.

The first support table 16 is provided between the follower roller unit 12 and the drive roller 14. An upper face 17 of the first support table 16 is configured as a flat face orthogonal to the height direction. The second support table 18 is further provided in front of the drive roller 14. An upper face 19 of the second support table 18 is configured as a flat face positioned one step lower than the upper face 17 of the first support table 16 and orthogonal to the height direction. The transport device 20 is provided directly above the second support table 18. The transport device 20 is configured by plural pairs of upper-lower drive rollers (omitted in the drawings) arranged in a row along the front-rear direction.

The follower roller 22, the adhesive coating device 24, and the first cutting device 26 are provided at the right side of, and in the vicinity of, a rear end portion of the second support table 18, as illustrated in FIG. 2. One end portion of a flexible strip-shaped electrode member (electrode) 29 is wound into the follower roller 22, which is rotatable about a rotation axis extending in the front-rear direction. The electrode member 29 is, for example, made from copper foil. Another end portion of the electrode member 29 extends from the follower roller 22 toward the left and is placed on the upper face 19 of the second support table 18. The adhesive coating device 24 coats a conductive adhesive onto the upper face of the electrode member 29. The first cutting device 26 is capable of cutting the electrode member 29 along the front-rear direction. The second cutting device 28 is further provided directly above, and in the vicinity of, a rear end portion of the second support table 18. The second cutting device 28 is capable of cutting the electrode member 29 along the left-right direction. The pressing device 25 is movable in the height direction and is provided directly above, and in the vicinity of, a rear end portion of the second support table 18.

A strip-shaped body 30 that extends along a specific direction is wound onto each of the rollers 13 of the follower roller unit 12 of the manufacturing device 10 configured as described above. The strip-shaped bodies 30 each include a flexible strip-shaped base paper 32 that extends along the specific direction, and a flexible strip-shaped cloth 34 that is temporarily fixed to (temporarily held on) one face of the base paper 32 by adhesive. As illustrated in FIG. 2, the width (left-right dimension) of the base paper 32 is greater than the width of the cloth 34, and the width of the base paper 32 is slightly smaller than the width of each of the rollers 13. A front portion of each of the strip-shaped bodies 30 extends forward from each of the rollers 13, passes forward through directly above the upper face 17 of the first support table 16, and is positioned further forward than the front edge of the first support table 16. The front end portion of the base paper 32 that has been peeled away from a lower face of the cloth 34 is wound onto the drive roller 14.

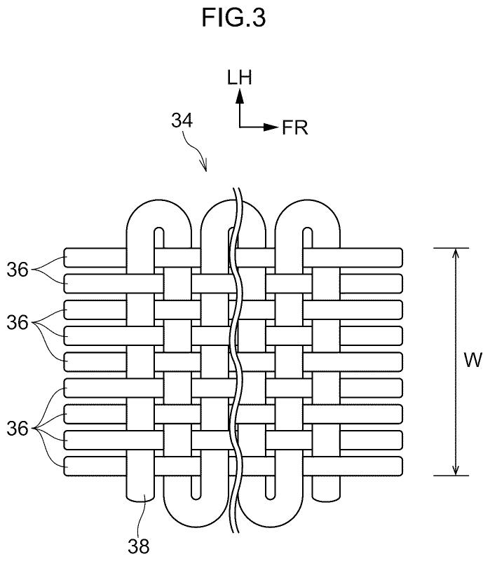

As illustrated in FIG. 3, the cloth 34 is configured by taking plural electrothermal warp threads 36, which extend in the front-rear direction and are arranged in a row along the left-right direction, and weaving them together with a single strand of weft thread 38. There is no particular limitation to the weaving method of the electrothermal warp threads 36 and the weft thread 38. Such a weaving method includes, for example, plain weave, twill weave, or satin weave. Note that the cloth 34 illustrated in FIG. 3 is a plain weave cloth. The electrothermal warp threads 36 contain carbon nanotubes (hereafter referred to as CNTs). Heat is generated in the electrothermal warp threads 36 when electricity flows through the electrothermal warp threads 36, with the CNTs acting as resistors (heat generation bodies). Various materials may be utilized as the material of the weft thread 38. The material of the weft thread 38 is a material that generates substantially no heat when supplied with electricity. The cloth 34 of the present exemplary embodiment is manufactured such that its width (left-right dimension) is a specific width W (see FIG. 3).

Description follows regarding a manufacturing method of a planar heater 45 utilizing the manufacturing device 10 and the strip-shaped body 30.

The drive roller 14 rotates in the arrow B direction by the drive device 15 being operated, and the base papers 32 are taken up on the drive roller 14. Each of the strip-shaped bodies 30 having one end side wound onto the respective roller 13 is thereby transported in the arrow D1 direction of FIG. 1. The drive roller 14 temporarily stops when each of the strip-shaped bodies 30 has been transported forward by a specific forward transport distance. A process by which the strip-shaped body 30 is transported the forward transport distance by the drive roller 14 in this manner is referred to as a strip-shaped body transport step (transport step).

Due to the drive roller 14 taking up the base paper 32, the base paper 32 is peeled away from a lower face of the cloth 34. The process by which the base paper 32 is peeled away from the lower face of the cloth 34 by the drive roller 14 in this manner is referred to as a separation step.

The electrode member 29 is moreover moved a specific width direction transport distance in an arrow D2 direction of FIG. 2 by a width direction feed device (omitted in the drawings). The D2 direction is parallel to the left-right direction in plan view. When the electrode member 29 moves in the D2 direction by the width direction transport distance, a leading end (left end) of the electrode member 29 passes through to the left side between the lower face of the five cloths 34 and the upper face 19 of the second support table 18, and stops at the position illustrated in FIG. 2. The process by which the electrode member 29 is transported the width direction transport distance by the width direction feed device is referred to as an electrode transport step.

Moreover, when the leading end of the electrode member 29 passes below the adhesive coating device 24, the adhesive coating device 24 coats a conductive adhesive (omitted in the drawings) onto an upper face of the electrode member 29. The conductive adhesive is thereby coated onto all areas of the upper face of the electrode member 29, including locations positioned directly below the adhesive coating device 24 and the leading end of the electrode member 29 (locations positioned more to the left side that the leftmost cloth 34). The process in which the adhesive is coated onto the electrode member 29 by the adhesive coating device 24 in this manner is referred to as an adhesive coating step (electrode connection step).

Moreover, the pressing device 25 (see the broken lines in FIG. 1) disposed above the second support table 18 moves the five cloths 34 downward while moving downward from an initial position illustrated by the broken lines in FIG. 1, and presses the five cloths 34 against the upper face of the electrode member 29 positioned directly below the cloth 34. The electrode member 29 is accordingly fixed to the five cloths 34 by the adhesive coated onto the upper face of the electrode member 29. Namely, the electrode member 29 and the five cloths 34 are integrated together. The pressing device 25 then returns to the initial position after a specific period of time has elapsed. The process in which the electrode member 29 is fixed to the five cloths 34 by the pressing device 25 so as to be connected to each of the electrothermal warp threads 36 through the conductive adhesive is referred to as an integration step (electrode connection step).

A location of the electrode member 29 at a position further to the right side than the cloth 34 furthest to the right side is then cut along the front-rear direction by the first cutting device 26. An electrode configuration section 29A is accordingly configured cut out from the electrode member 29 and fixed to the five cloths 34. A left end portion of the electrode configuration section 29A is positioned further to the left side than the leftmost cloth 34, and a right end portion of the electrode configuration section 29A is positioned further to the right side than the rightmost cloth 34. The process in which the electrode member 29 is cut by the first cutting device 26 in this manner is referred to as a first cutting step.

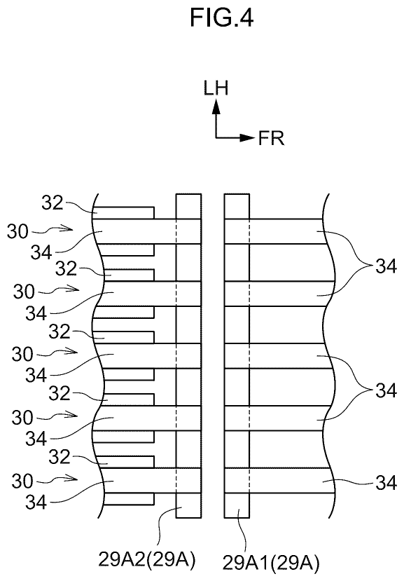

Following on therefrom, the second cutting device 28 that was positioned at the initial position (position indicated by solid lines in FIG. 1), which is a position directly above the rightmost cloth 34, is moved downward, and a right end portion of the electrode configuration section 29A and a right half of the rightmost cloth 34 are cut along a cut line CL (see FIG. 2), which is a straight line passing in the left-right direction through a width direction center portion of the electrode configuration section 29A. The second cutting device 28 is then moved further in a straight line toward the left side along the cut line CL, while maintaining the same height. All of the electrode configuration section 29A and the five cloths 34 are thereby cut along the cut line CL. Namely, as illustrated in FIG. 4, the electrode configuration section 29A is divided into a positive electrode section (electrode) 29A1 at the front of the cut line CL and a negative electrode section (electrode) 29A2 at the rear of the cut line CL. The second cutting device 28 then returns to the initial position. The process in which the electrode member 29 and the cloths 34 are cut by the second cutting device 28 is referred to as a second cutting step (cutting step).

The transport device 20 is operated after the second cutting device 28 has returned to the initial position, and the five cloths 34 that are sandwiched from above and below by the upper and lower drive rollers of the transport device 20 and that are positioned in front of the cut line CL are thereby moved to a discharge position in front of the second support table 18. The process in which the five cloths 34 positioned in front of the cut line CL are moved by the transport device 20 to the discharge position is referred to as a discharge step.

When the strip-shaped body transport step and the separation step are then executed again by the drive roller 14, the strip-shaped bodies 30 are transported by the forward transport distance, and the base papers 32 are peeled away from the lower face of the cloths 34. The negative electrode section 29A2 positioned directly below the second cutting device 28 is thereby moved as far as the front end position PF illustrated in FIG. 2.

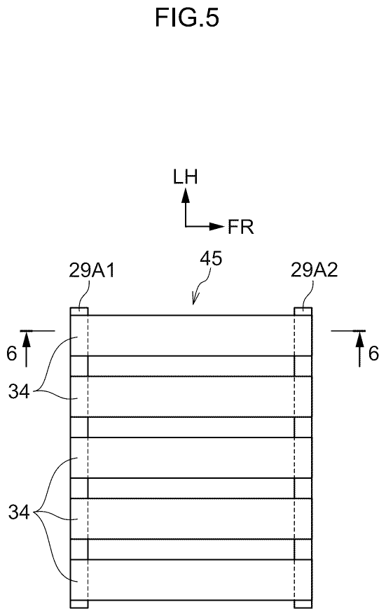

When the electrode transport step, the adhesive coating step, the integration step, the first cutting step, and the second cutting step have been executed, this completes the planar heater 45 that is positioned in front of the second cutting device 28, and is equipped with the five cloths 34, the negative electrode section 29A2 fixed to the front end portions of the five cloths 34, and the positive electrode section 29A1 fixed to the rear end portion of the five cloths 34 (see FIG. 2 and FIG. 5).

Plural of the planar heaters 45 are manufactured by repeatedly executing the discharge step, the strip-shaped body transport step, the separation step, the electrode transport step, the adhesive coating step, the integration step, the first cutting step, and the second cutting step, and the plural planar heaters 45 are moved to the discharge position.

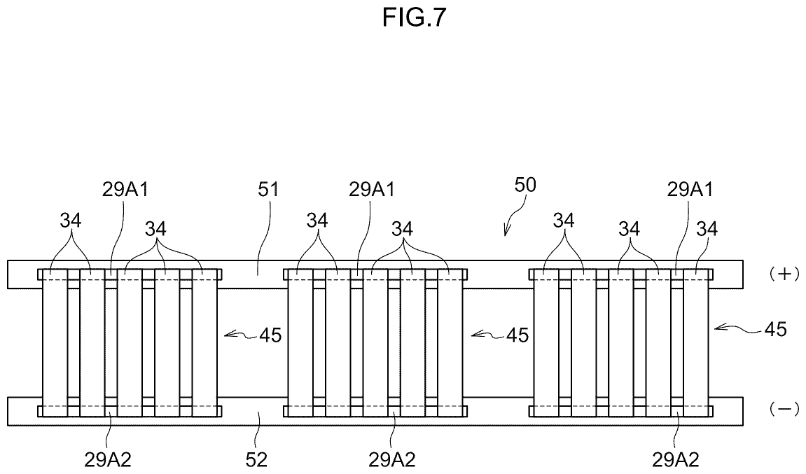

The plural planar heaters 45 manufactured in this manner are configuration elements of a heating device 50 as illustrated in FIG. 7. The heating device 50 includes a single strip-shaped positive electrode conductor 51 extending in a straight line and having conductive and flexible properties, a single strip-shaped negative electrode conductor 52 extending in a straight line and having conductive and flexible properties, three of the planar heaters 45 in which a face on the opposite side of the positive electrode section 29A1 to the cloth 34 is fixed to one face of the positive electrode conductor 51 through a conductive adhesive, and in which a face on the opposite side of the negative electrode section 29A2 to the cloth 34 is fixed to one face of the negative electrode conductor 52 through a conductive adhesive, and a covering material (omitted in the drawings) with electrically insulating properties covering all surfaces of the positive electrode conductor 51, the negative electrode conductor 52, and the planar heater 45.

The heating device 50 is, for example, provided inside a seat cushion of a vehicle seat, and the positive electrode conductor 51 and the negative electrode conductor 52 are connected to a power source through a control device. When electrical power of the power source is supplied to the positive electrode conductor 51 and the negative electrode conductor 52, current that has flowed through the positive electrode conductor 51 flows to each of the positive electrode sections 29A1 of the planar heaters 45 and to each of the negative electrode sections 29A2 through the electrothermal warp threads 36 of the cloth 34, and further flows onward from each of the negative electrode sections 29A2 to the negative electrode conductor 52. Each of the electrothermal warp threads 36 generates heat when current flows in each of the electrothermal warp threads 36.

Next, description follows regarding operation and advantageous effects of the present exemplary embodiment.

In the manufacturing method of the planar heater 45 of the present exemplary embodiment, the strip-shaped bodies 30 are transported in the front-rear direction by the manufacturing device 10. Each of the strip-shaped bodies 30 extends in the front-rear direction (orthogonal direction) and includes the plural electrothermal warp threads 36 containing CNTs that generate heat when electricity flows therethrough and that are arranged in a row along the left-right direction (one direction) and the single strand of weft thread 38 that together with the electrothermal warp threads 36 configures the cloth 34. The electrode member 29 (the positive electrode section 29A1, and the negative electrode section 29A2) is connected to the strip-shaped bodies 30 so as to contact the plural electrothermal warp threads 36. Namely, the manufacturing method of the planar heater 45 of the present exemplary embodiment does not include a process to change a width (left-right dimension) of the strip-shaped body (the planar heater 45) to a specific width W by cutting the strip-shaped body along the front-rear direction (extension direction of the strip-shaped body 30). Namely, the planar heater 45 is manufactured without performing a process to change a width of a strip-shaped body to a specific width W. The manufacturing method accordingly gives rise to little concern regarding breaking the electrothermal warp threads 36 of the planar heater 45.

Furthermore, in the manufacturing method of the planar heater 45 of the present exemplary embodiment, the strip-shaped body 30 transported forward in the strip-shaped body transport step (transport step) includes the base paper 32 that extends in the front-rear direction and temporarily holds (temporarily fixes) the electrothermal warp threads 36 and the weft thread 38 on one face thereof. The manufacturing method further includes a separation step in which the base paper 32 is separated from the electrothermal warp threads 36 and the weft thread 38. The planar heater 45 is accordingly easily manufactured while maintaining positional relationships of each of the electrothermal warp threads 36 in the strip-shaped body 30.

Furthermore, the manufacturing method of the planar heater 45 of the present exemplary embodiment includes a second cutting step (cutting step) to cut the strip-shaped bodies 30 and the electrode configuration section 29A along the cut line CL, which is a straight line passing in the left-right direction (extension direction of the electrode configuration section 29A) through the width direction center portion of the electrode configuration section 29A. Two electrode sections (the positive electrode section 29A1 and the negative electrode sections 29A2) can accordingly be manufactured by a cutting processing performed once by the second cutting device 28.

Furthermore, as illustrated in FIG. 5, left end portions of the positive electrode section 29A1 and the negative electrode sections 29A2 of the planar heater 45 project out further to the left side than the leftmost cloth 34, and right end portions of the positive electrode section 29A1 and the negative electrode sections 29A2 project out further to the right side than the rightmost cloth 34. This means that the positive electrode section 29A1 and the positive electrode conductor 51 can be fixed together through adhesive, and the negative electrode sections 29A2 and the negative electrode conductor 52 can be fixed together through adhesive, while both the right and left end portions of the positive electrode section 29A1 and the negative electrode sections 29A2 of the planar heater 45 are being gripped by a gripping device of a transport robot (omitted in the drawings). Namely, the planar heater 45 can be bonded to the positive electrode conductor 51 and the negative electrode conductor 52 without damaging the positive electrode section 29A1 and the negative electrode sections 29A2 with the gripping device.

Although an exemplary embodiment of the present disclosure has been described above, the present disclosure is not limited by the above exemplary embodiment.

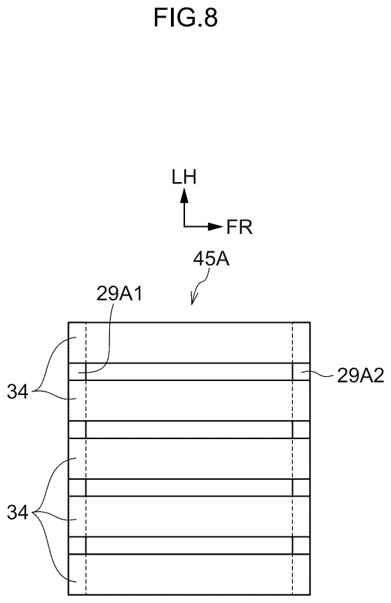

For example, a planar heater 45A may be manufactured by a first modified example illustrated in FIG. 8. The position of the left ends of the positive electrode section 29A1 and the negative electrode sections 29A2 of the planar heater 45A are aligned with the left side edge portion of the leftmost positioned cloth 34, and the position of the right ends of the positive electrode section 29A1 and the negative electrode sections 29A2 are aligned with the right side edge portion of the rightmost positioned cloth 34. In the first modified example, the electrode member 29 is transported in the electrode transport step toward the left side such that the leading end (left end) of the electrode member 29 is positioned directly below the left side edge portion of the leftmost positioned cloth 34. Moreover, in the first cutting step, the electrode member 29 is cut by the first cutting device 26 such that the right end of the electrode configuration section 29A is aligned with the right side edge portion of the rightmost positioned cloth 34. In the first modified example a length (size) of the positive electrode section 29A1 and the negative electrode sections 29A2 of each of the planar heaters 45A is smaller than for the planar heaters 45, and so each of the planar heaters 45A is able to be manufactured at lower manufacturing cost.

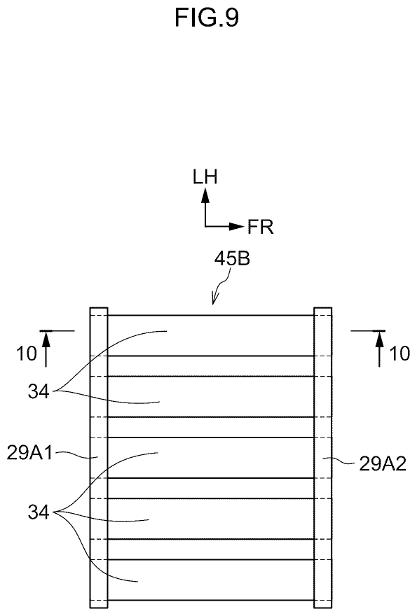

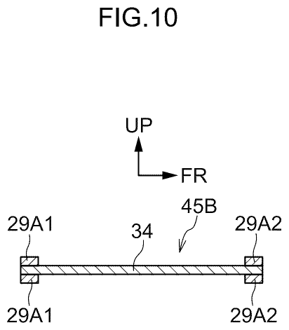

A planar heater 45B may be manufactured as in the second modified example illustrated in FIG. 9 and FIG. 10. In the planar heater 45B, positive electrode sections 29A1 and negative electrode sections 29A2 are fixed to the upper and lower faces of each of the cloths 34 through conductive adhesive, and opposing faces of the upper and lower positive electrode section 29A1 and opposing faces of the upper and lower negative electrode sections 29A2 are fixed together through the conductive adhesive. In the second modified example, in the electrode transport step, an electrode member 29 positioned below each of the cloths 34 and an electrode member 29 positioned above each of the cloths 34 are transported in the D2 direction by the width direction feed device. Furthermore, in the adhesive coating step, the upper face of the lower side electrode member 29 and the lower face of the upper side electrode member 29 are coated in conductive adhesive by the adhesive coating device 24. Moreover, in the integration step (electrode connection step), while the pressing device 25 is being moved downward from the initial position, the electrode member 29 positioned at the upper side is pressed against the upper face of the five cloths 34, and the lower faces of the five cloths 34 are pressed against the electrode member 29 positioned at the lower side.

Any number of the cloths 34 may be employed in the planar heaters 45, 45A, 45B of the exemplary embodiment and each of the modified examples.

As long as there are plural planar heaters 45, 45A, 45B included in the heating device 50 there may be any number thereof.

The strip-shaped body 30 of the exemplary embodiment and each of the modified examples may be configured without the base paper 32.

The position of the left ends of the positive electrode section 29A1 and the negative electrode sections 29A2 of the planar heater 45B of the second modified example may be aligned with the left side edge portion of the leftmost positioned cloth 34, and the positions of the right ends of the positive electrode section 29A1 and the negative electrode sections 29A2 may be aligned with the right side edge portions of the rightmost positioned cloth 34.

The adhesive coating device 24 may coat the conductive adhesive onto the electrode member 29 only at locations to be connected to each of the cloths 34.

Moreover, in the exemplary embodiment and each of the modified examples, the electrode transport step may be implemented by a step in which the electrode member 29 directly above each of the cloths 34 is transported toward the right side, the adhesive coating step may be a step in which conductive adhesive is coated on the lower face of the electrode member 29, the integration step may be a step in which each of the cloths 34 is moved upward to be pressed against the lower face of the electrode member 29 positioned directly above the cloths 34, the second cutting step may be a step in which the electrode member 29, the cloths 34, and the base papers 32 are cut, and furthermore, the separation step to peel the base papers 32 away from the upper faces of the cloths 34 may be executed after the second cutting step. This modified example has the base papers 32 being integrated together with the cloths 34 until the second cutting step is completed, and so the second cutting step can be executed in a state in which positional relationships are held between the cloths 34 and the electrode member 29.

Moreover, in the exemplary embodiment and each of the modified examples, the plural cloths 34 may be temporarily fixed to a single sheet of base paper having a large left-right dimension (width).

What is claimed is:

1. A planar heater manufacturing method comprising:
transporting a strip-shaped body, the strip-shaped body including a plurality of electrothermal warp threads that generate heat when electricity flows therethrough and that are arranged in a row along one direction, including a single strand of weft thread that together with the electrothermal warp threads configures a cloth, and extending in an orthogonal direction that is orthogonal to the one direction, by transporting the strip-shaped body in the orthogonal direction; and
connecting an electrode to the strip-shaped body so as to contact the plurality of electrothermal warp threads.

2. The planar heater manufacturing method of claim 1, wherein:
the strip-shaped body to be transported also includes a base paper that extends in the orthogonal direction and that temporarily holds the electrothermal warp threads and the weft thread on one face of the base paper; and
the planar heater manufacturing method further comprises separating the base paper from the electrothermal warp threads and the weft thread.

3. The planar heater manufacturing method of claim 1, wherein:
the electrode is strip-shaped extending in the one direction; and
the planar heater manufacturing method further comprises cutting the strip-shaped body and the electrode along a cut line that is a straight line passing through a width direction center portion of the electrode in the one direction.

4. A planar heater comprising:
a plurality of electrothermal warp threads that generate heat when electricity flows therethrough and that are arranged in a row along one direction;
a single strand of weft thread that, together with the electrothermal warp threads, configures a strip-shaped body that is a cloth extending in an orthogonal direction that is orthogonal to the one direction; and
a negative electrode section and a positive electrode section that have been connected to the plurality of electrothermal warp threads.

5. A heating device comprising:
a plurality of planar heaters of claim 4;
a negative electrode conductor that has been connected to negative electrode sections of the plurality of planar heaters; and
a positive electrode conductor that has been connected to positive electrode sections of the plurality of planar heaters.
